(19) United States
(12) Patent Application Publication
(10) Pub. No.: US 2003/0139974 A1
(43) Pub. Date: Jul. 24, 2003

(54) Method of purchasing goods on internet through identification of actual object

(76) Inventor: Keun-Woo Lee, Seoul (KR)

Correspondence Address: CANTOR COLBURN, LLP, 55 GRIFFIN ROAD SOUTH, BLOOMFIELD, CT, 06002

(21) Appl. No.: 10/275,798

(22) PCT Filed: May 25, 2001
(86) PCT No.: PCT/KR01/00872

(30) Foreign Application Priority Data
May 25, 2000 (KR) 2000/28449

(51) Int. Cl. G06F 17/60

(52) U.S. Cl. 705/26

(57) ABSTRACT

A method of purchasing goods in the Internet electronic commerce, which enables a user to identify the goods actually, includes the steps of registering the user as a member and endowing the user with ID, allocating a virtual cart to each member and issuing a membership card, then the member inputting product information of goods to be potentially purchased with the membership card in an actual store, and then displaying the product information stored in the virtual cart to the user through Internet so that the user selects goods for purchasing.

### TECHNICAL FIELD

The present invention relates to a goods purchasing method, which enables buyers to purchase goods in an Internet Electronic Commerce system through checking an actual entity of the goods in a real-world store, and more particularly to a goods purchasing method, which allows buyers to purchase goods via online shopping (E-Commerce) through Internet after personally observing and understanding the characteristics about the actual entities of the goods.

### BACKGROUND ART

Generally, for a commercial transaction, it is required to build a distribution channel from an enterprise through wholesale dealers and retail dealers to consumers. Also, there are needed many sales people to understand the demand of customers as well as a suitable place for exhibition of the goods.

However, such a commercial transaction has some problems in that the region of transaction and a business hour are both limited to a certain range, and moreover the need of a place for the sales is inevitable.

Recently, the problems listed as above have been somewhat solved by constructing online shopping malls using the Internet. The Internet shopping malls give advantages of shortening the distribution channel from the enterprise directly to consumers, no limitations in time and place for a transaction, and not requiring a place for sales in fact that a sales base moved to a cyber space.

The Electronic Commerce (EC) refers to the behavior of buying and selling products online by using the Internet or PC communication. In a broad sense, the EC includes all of purchasing goods and services, ordering, and advertising activities, etc. accomplished through a computer network.

Such Electronic Commerce is most advantageous in the facts that there are no limitations in time and place, saving the buyers trouble of having to go to a shop in person, and the payment of a transaction is settled mainly by a credit. In addition, the EC (or E-Commerce) is occasionally referred to as the leading gold fishery in points that there is no need to cost for distribution or rental of a building, and all Internet users around the world can be potential consumers. The EC is sometimes considered as the commerce at the light speed (CALS).

Therefore, the large-scaled shopping malls are becoming prevalent through the Internet or the PC communications network for the Electronic Commerce.

However, even the transactions using such shopping mall have problems as follow.

In the Electronic Commerce using the Internet, a buyer cannot view an actual entity of a product (or an article) in person, so should determine whether or not to purchase the product only with a figure or picture of the product through the Internet. Therefore, a consumer may mistrust an expected quality of the product, which causes shrinkage of buyers' interest. Particularly, since the Electronic Commerce is performed in a cyber space, namely Internet, there are more possibilities that the customer may suffer more loss than the case of the real world.

### DISCLOSURE OF INVENTION

The present invention is designed to overcome the problems of the prior art. An object of the invention is to provide a method of purchasing goods in the Internet after identifying an actual entity of the goods, with which a consumer may purchase the goods in the Electronic Commerce using the Internet after checking characteristics of the goods by observing the goods actually in person.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows an embodiment of an Internet Electronic Commerce according to the present invention;

FIG. 2 shows another embodiment of the Internet Electronic Commerce according to the present invention;

FIG. 3 is a schematic diagram for illustrating the method of purchasing goods through identification of their actual entity according to the present invention;

FIG. 4 is an example of an ID card in a shape of business card and a product catalogue used in the present invention;

FIG. 5 is a flow chart for illustrating the method of purchasing goods through identification of their actual entity according to an embodiment of the present invention; and

FIG. 6 is a flow chart for illustrating the method of purchasing goods through identification of their actual entity according to another embodiment of the present invention.

### BEST MODES FOR CARRYING OUT THE INVENTION

Hereinafter, preferred embodiments of the present invention will be described in detail with reference to the accompanying drawings.

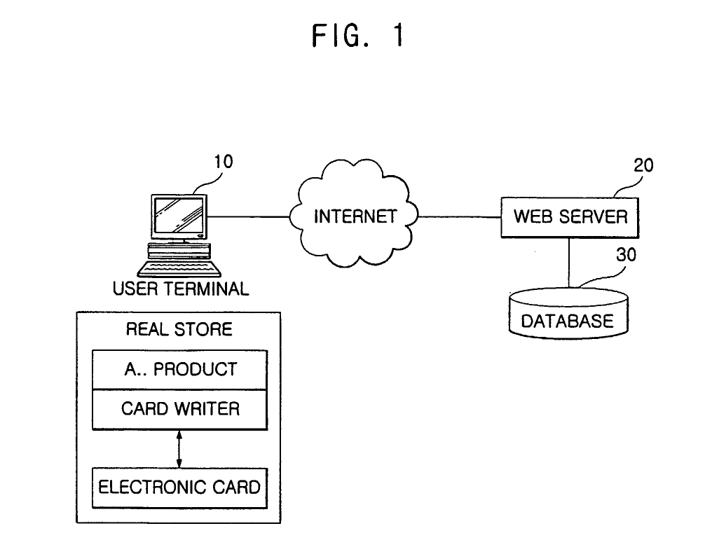

FIG. 1 exemplarily shows an Internet Electronic Commerce (EC) system to which the present invention is applied.

As shown in FIG. 1, the EC system includes user terminals 10 for users, a web server 20, to which a user who desires to access an Internet shopping mall is connected through an information communications network (preferably, Internet) by using the user terminal 10, and a database 30 linked to the web server 20 to store data such as user information, shopping mall-related information, product information and advertisement information.

Here, the user terminal 10 may be one of the following; Personal Computer (PC), next generation mobile communication terminal such as IMT-2000 (International Mobile Telecommunication) and UMTS (Universal Mobile Telecommunication Service), PDA (Personal Digital Assistant), notebook, etc.

However, the hardware environments composed as above are no more than a technique already well known in the art, and not described here in detail. In this embodiment, just a scheme for a buyer to purchase a product in an Internet shopping mall after observing an actual entity of the product in a real store will be described in greater detail.

First of all, a service provider of the Internet shopping mall issues an electronic card to members for ensuring secure transmission and management of payment-related information like purchasing information and credit card information over the Internet by using public-key encryption and private-key encryption. Such an electronic card may be a touch/non-touch IC or RF card in a shape of a business card with a memory function.

As shown in FIG. 1, a buyer carrying such an electronic card (or, member card), confirms functions and quality of a real product exhibited in a real store, which is a store in the real world, in person. Then, onto the member card, the real store issues a product ID, containing a product classification code, a store classification code, a date of issue, etc., about a product to be purchased. At this time, a terminal or a card writer can be provided inside the real store for each product or each product group independently so that the card writer could write the product ID of that product onto the electronic card possessed by the buyer when the buyer either brings the electronic card into contact with or inserts into the card writer. Or else, a shop assistant may carry the card writer so as to directly write the product ID onto the electronic card of the buyer.

After that, the buyer accesses the web server 20 through the information communications network (preferably, Internet), collects and confirms various detailed information about the products selected by shopping in the real store, and then finally places an order of the product. In this case, a card reader should be prepared in the user terminal 10 so that, if the buyer inserts the electronic card into the card reader, a dedicated program installed in the user terminal transmits the product ID to the web server 20. And then, the web server 20 analyzes the product ID to display detailed information about the corresponding product through the web browser of the user terminal.

Next, the buyer finally determines whether to order the product and then purchases the product according to a predetermined purchasing procedure. In this case, the information regarding an ordered product is informed to the real store as well as a product manufacturer and a delivery service provider so as to manufacture and deliver the product to the buyer.

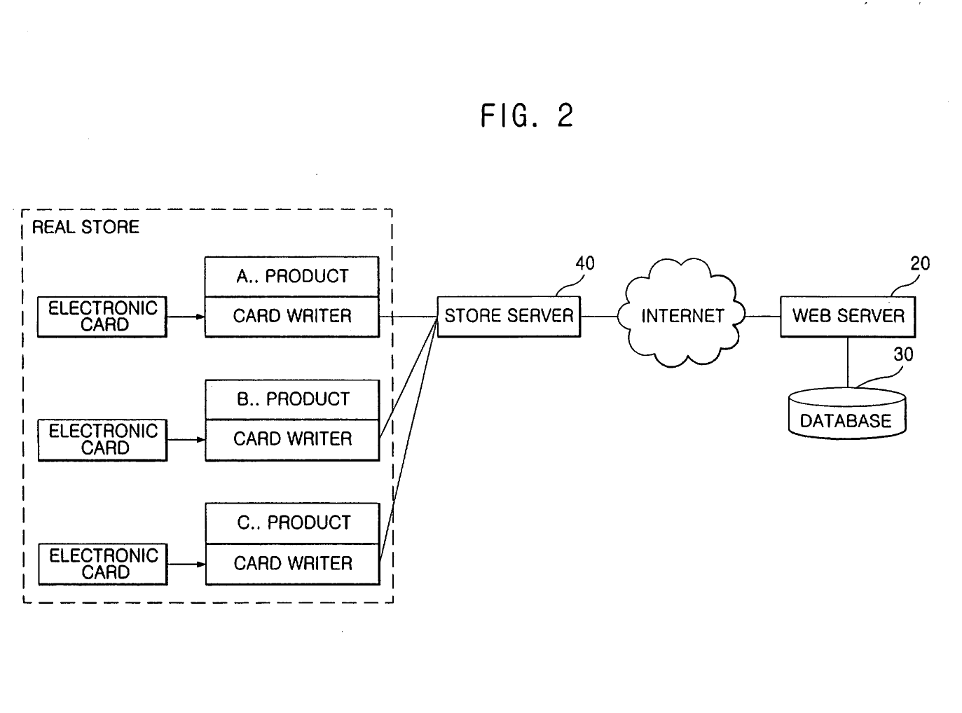

Meanwhile, alternatively as shown in FIG. 2, a buyer with an electronic card (or, a member card) confirms the functions and quality of a product exhibited in a real store, which is a store in the real world, like the case of FIG. 1. However, when the buyer brings the electronic card into contact with or inserts into the card writer, provided to each product or each product group, the card writer transmits the corresponding product ID to the store server 40. Then, the store server 40 collects each product ID of all the selected products and then places the product IDs into the virtual cart within the web server 20, assigned to each member.

At this point, it is also possible to provide a terminal for each product so that the terminal may by itself transmits the product ID directly to the virtual cart, assigned to each member inside the web server 20, without passing through the store server 40. In this case, it is apparent that such a modification shows same effects, therefore should be considered as an equivalence of the former embodiment. Besides, it is also possible to provide just one terminal for one product group or a plurality of products instead of providing one terminal for one product so that the buyer may select a desired product from the corresponding terminal and then transmit the relevant product ID at the corresponding terminal.

After this, the buyer may access the web server 20 through the information communications network (preferably, Internet) and open the virtual cart so as to collect various detailed information about the selected products, check the products again and finally decide whether to order the products. At this time, the web server 20 analyzes the product ID and outputs detailed information of the products through the web browser of the user terminal. Of course, it is also possible that the buyer uses the store server 40 installed in the real store to access the web server 20 for collecting various detailed information about the selected products, checking the products again and finally deciding whether to order the products.

Then, the buyer finally determines whether to order the product and then purchases the products according to a predetermined purchasing procedure. In this case, the product information regarding an ordered product is informed of the real store as well as a product manufacturer and a delivery service provider so as to manufacture and deliver the product to the buyer.

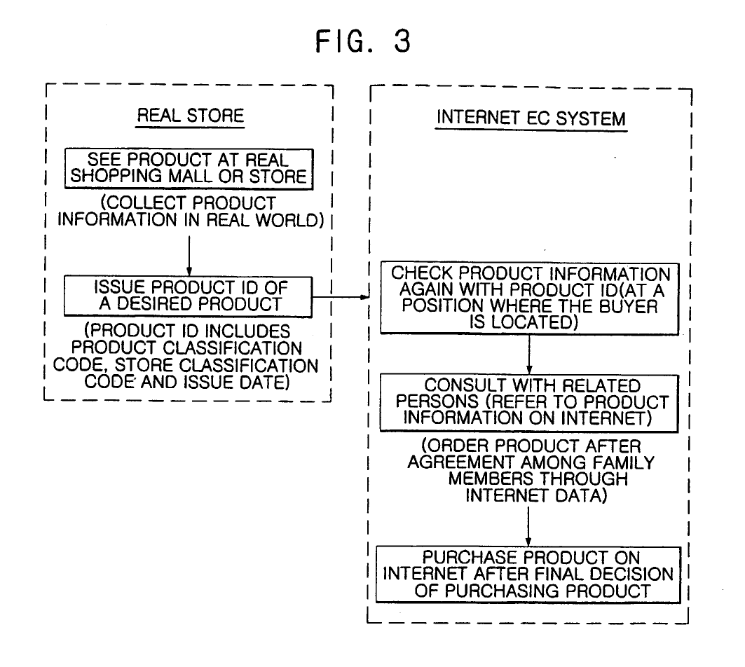

FIG. 3 is a schematic view exemplarily showing the method of purchasing goods through identification of an actual entity of the goods according to the present invention.

As shown in FIG. 3, in the method of purchasing goods through identification of an actual entity of the goods, a buyer observes and confirms functions and quality of a product exhibited in the real store in advance, and then may receives a document which is issued from the store and contains the product ID.

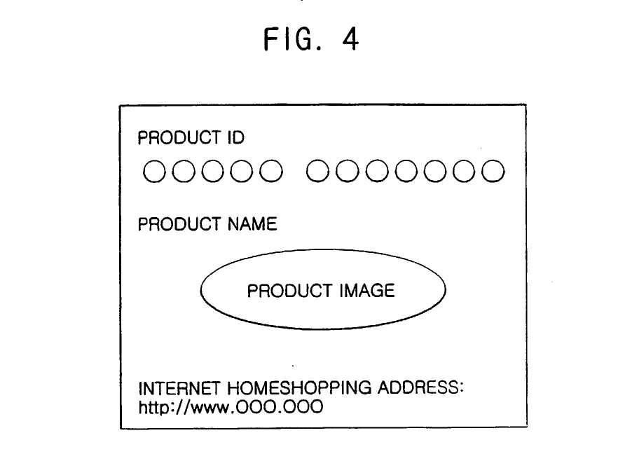

The document containing the product ID may be a card in shape of a business card or a guidebook in shape of a catalogue, and one example is shown in FIG. 4.

Then, the buyer collects various information about the product from the Internet Electronic Commerce system by using the product ID written in the issued document, checks the product again, and then finally places an order of the product after having a conference with other persons in relation to making decision on purchasing the product.

At this time, if the buyer accesses the web server 20, the web server 20 provides a product ID input portion in a main screen. Therefore, the buyer could easily access a site, which provides detailed information of the product, just by inputting the product ID in the product ID input portion.

The product information providing site may contain data such as product image, product characteristic description, product price, etc. The site may be connected to an electronic payment system for product purchasing, and, in some cases, connected directly to a homepage of a product manufacturer or a selling store.

The linkage between the product ID and the detailed product information can be integrally managed by the service provider together with the product information. Or else, a manager of the store may make various necessary product information and provide the information to the web server 20 by uploading it. Of course, the present invention is not limited to those cases, but there may be other modifications.

The product ID can be configured as follows, for convenience of its management.

Product ID: 0 0 0 0 0_{—}0 0 0 0 0 0 0_{—}0 0 0 0 0

(store classification code)_(product classification code)_(date of issue)

The store classification code is endowed voluntarily in principle from the real store, while the product classification code, being justified by the manufacturer, is then endowed in principle. In such a case, when shipping a product, the manufacturer may write the product classification code in the electronic card or in a product catalogue or a bar code before providing the product to the store. Then, the store may add the store classification code to the product so as to create the product ID. At this time, the catalogue for each product exhibited in the real store may be configured as shown in FIG. 4.

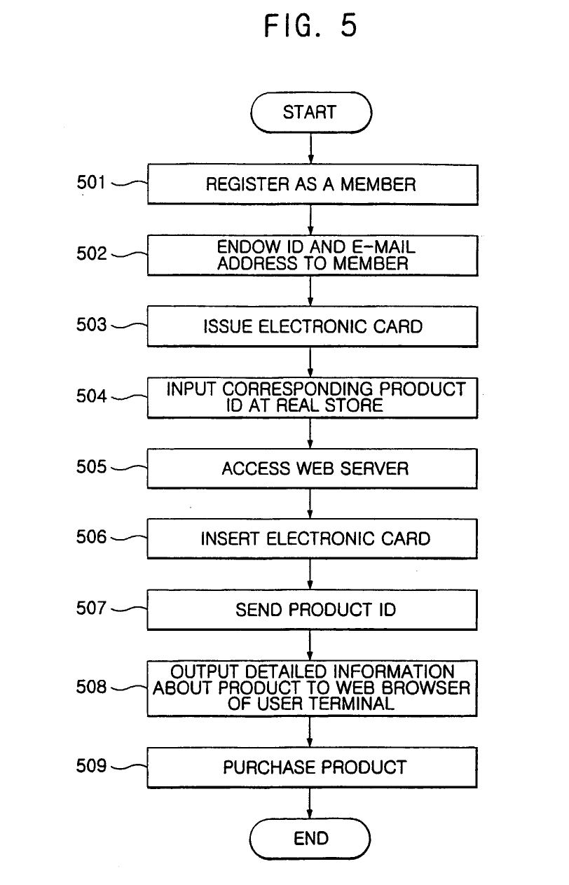

FIG. 5 is a flowchart exemplarily showing the method of purchasing goods through identification of a real entity of the goods according to the present invention.

As shown in FIG. 5, in the method of purchasing goods through identification of an actual entity of the goods according to the present invention, a service user (buyer), who desires to purchase a product after checking an actual entity of the product in the real store, accesses the web server 20 and inputs user information at a site, which implements the method of the present invention, so as to be registered as a member (step 501).

At this time, the buyer sets his/her own ID and secret number and may set an account used for paying a price of a purchased product. At this time, the account may be an account of an existing bank or an account associated with a credit card, and should be understood that it is a concept including any existing payment system. In case of using the credit card, the user may not deposit money in advance.

When a cyber account is used, it is easier to manage a bankbook or withdraw money and more convenient to check whether the account has so sufficient money to pay a price of a product to be purchased. In case of using an account of a general bank (not a cyber bank), it may happen trouble that there is checked the sufficient balance in the account when requesting to purchase the product, but there remains not enough balance when the buyer withdraw the price of the purchased product. However, the cyber account does not cause such a problem, advantageously.

After that, the service provider endows a member ID and an e-mail address to the registered member at the site (step 502). Also, a member card, which is a writable IC electronic card, is issued to the member (step 503). The IC electronic card is made to have EEPROM so that the product ID may be stored therein.

Then, the member, who receives the member card, is issued with the product ID of a product, which the member wants to buy, at the real store (step 504).

At this time, a device for issuing the product ID may be ‘a product ID card writer’, which is installed to each product or each product group and inputs the product ID in the IC electronic card when the member brings into contact or inserts the IC electronic card thereto, or ‘a portable card writer’, which is carried by a store clerk who helps the product ID for a product to be input in the IC electronic card as the member desires.

The portable card writer includes an input device such as a keyboard, a bar code recognizing device and a product ID writing device so to be carried by a person. When the product classification code is input with the bar code recognizing device or the keyboard input device, the product classification code is combined with the store classification code and the date of issue to convert into the product ID. The converted product ID is then inputted into the IC electronic card of the member by the product ID writing device.

Therefore, the member may obtain the product ID of a desired product during observing the product in the real store, which is affiliated with the site.

After obtaining the product ID in the real store, the member accesses the site through the Internet service (step 505), and then brings the IC electronic card into contact with or inserts into ‘an IC electronic card reader’, provided to the user terminal 10 (step 506). Then, a program installed in the user terminal 10 sends the product ID, read by the IC electronic card reader, to the web server 20 together with the member ID (step 507).

Then, the web server 20 analyzes the sent product ID and displays detailed information about the product through a web browser of the user terminal of the member (step 508). At this time, the web server 20 has preferably already prepared the detailed information corresponding to the product ID in the database 30.

Finally, the member checks the detailed information about the product to be possibly purchased and then places an order of the product according to a predetermined purchasing procedure (step 509). At this time, in the purchasing procedure, the member may input user information (name, e-mail address, phone number, address, etc.), delivery information (name of a recipient, address of a recipient, gift, etc.), and payment information (a payment method, e.g. depositing without a bankbook or using a credit card).

The above information regarding an ordered product is informed to the real store as well as a product manufacturer and a delivery service provider so that the product may be delivered to the buyer after, if necessary, manufactured.

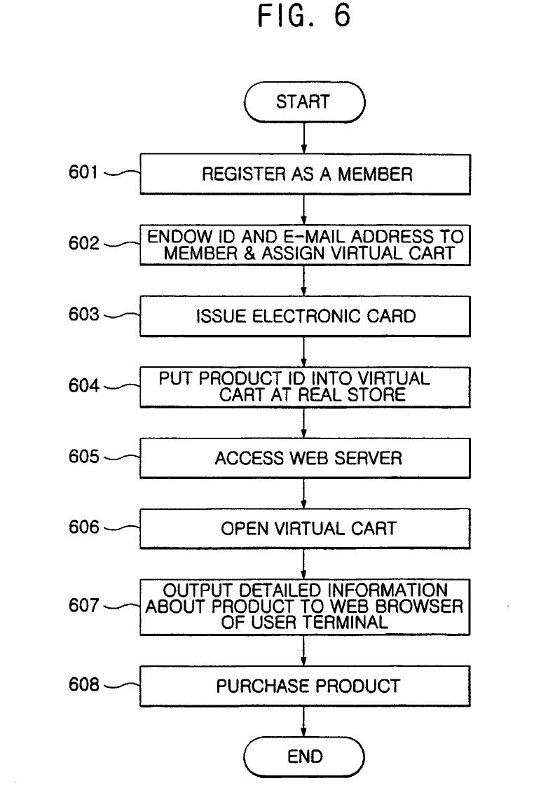

FIG. 6 is a flowchart showing the method of purchasing goods through identification of an actual entity of the goods according to another embodiment of the present invention.

As shown in FIG. 6, in the method of this embodiment, a service user (buyer), who desires to purchase a product after checking an actual entity of the product in the real store, accesses the web server 20 and inputs user information at a site, which implements the method of the present invention, so as to be registered as a member (step 601). At this time, the buyer sets his/her own ID and secret number and may set an account used for paying a price of a purchased product.

Then, the service provider of the site endows a member ID and an e-mail address to the registered member and at the same time assigns to each member a virtual cart, which is a virtual storage area in the shopping mall (step 602). Also, a member card, which is an IC electronic card containing the member ID and the e-mail information, is issued to the member (step 603). Such an electronic card may be a RF card or a touch/non-touch IC card, and not limited to any specific format. The IC electronic card may be used to input data into the virtual card. Here, the member ID and the e-mail address are endowed to the buyer when the buyer affiliates with the shopping mall as a member).

Then, the member having the member card presents the card for a desired product in the real product so as to put the product ID of the product into the virtual cart (step 604).

Now, a process of inputting the product ID into the virtual cart is described in detail.

If the member brings the IC electronic card into contact with or inserts into ‘the product ID card writer’ or ‘the portable card writer’ prepared for a desired product as shown in FIG. 5, the card writer sends the product ID to the store server 40 together with the member ID. The store server 40 then collects a plurality of sent product IDs and then inputs the product IDs into the virtual cart of the member. Or else, the store server 40 also may input each product ID into the virtual cart in real time. At this time, the web server 20 may input the product ID, sent from the store server 40, into the virtual cart of the member by using the user ID of the member. Or else, it is also possible that the store server 40 directly inputs the product ID into the virtual cart by using the e-mail address of the member.

All card writers (terminals) in the real store are connected to the store server 40 through an internal network. When using a portable terminal, the internal network can be a wireless network. Furthermore, the terminals may be directly connected to the web server 20, not through the store server 40, for the purpose of direct data transmission between them.

As described above, the member may put product ID(s) of desired product(s) into his/her own virtual cart during observing products exhibited in the real store affiliated with the site.

After putting the product ID in his/her own virtual cart, the member accesses the site of the web server through the Internet service (step 605), and opens the virtual cart by inputting the user ID of the member (step 606). At this time, the virtual cart contains the product ID(s), which is input by the member. If the member clicks the product ID, the web server outputs detailed information corresponding to the product ID through the web browser of the user terminal (step 607).

Finally, the member checks the detailed information about the product to be possibly purchased and then places an order of the product according to a predetermined purchasing procedure (step 608). At this time, in the purchasing procedure, the member may input user information (name, e-mail address, phone number, address, etc.), delivery information (name of a recipient, address of a recipient, gift, etc), and payment information (a payment method, e.g. depositing without a bankbook or using a credit card).

The above information regarding an ordered product can be informed to the real store as well as a product manufacturer and a delivery service provider so that the product may be delivered to the buyer after, if necessary, manufactured.

As an applicable example of the present invention, there is “a window-shopping mall”. The window-shopping mall means a shopping mall in the real world, which exhibits various products so that a person may look around the products as desires and obtain a product ID when the person finds a desired one. However, in the window-shopping mall, the person is allowed to just watch and check products but not allowed substantially to purchase any product. To purchase a product in the window-shopping mall, persons may use an ordering system, prepared at the shopping mall.

In the present invention, it is assumed that the product ID of a product to be purchased is issued to the member card, the member then collects and checks various information about the product by using the product ID in the Internet Electronic Commerce system, and then the member substantially purchases the product. However, instead of preparing the member card, a residence number or the fingerprint (or the iris) recognition technique may be used. In this case, like the above example, the member may put the product ID of a desired product into the virtual cart of the web server 20 by using the residence number or the recognition of the fingerprint (or the iris), accesses the web server 20 to check detailed information of the product, and then substantially purchases the product according to a predetermined purchasing procedure. This modification gives same effects as the above embodiment, so should be considered as equivalence.

In addition, it is also possible to issue the member with the member ID without the member card. In this case, the member may put the product ID of a desired product into the virtual cart of the web server 20 by inputting the member ID and the product ID. Or else, the member may obtain the product ID from a catalogue or a product information card distributed from the real store. In this case, the member may access the web server 20, input the product ID to the web server for getting detailed information corresponding to the product ID, and then purchase the product.

In order to input and send the member ID and the product ID of a desired product to the web server, there may be used an Internet-accessible mobile communication terminal of the member such as a cellular phone, IMT-2000 terminal, smart phone, PDA, etc. or a terminal prepared in the real store. At this time, the member may input the member ID by using keys or a bar code. Also, the product ID may be automatically transmitted from the terminal prepared for each product in the real store, as described above. In addition, the product ID may be obtained from a document such as a business card or a catalogue.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

The present invention as described above gives advantageous effects as follows.

Firstly, because a buyer can utilize various products information obtained from various real stores when intending to purchase a product at the virtual commerce system, it is possible for the buyer to discuss whether to purchase the product with other persons before ordering the product. In particular, it is more effective in the case that the buyer is difficult to visit the store due to a restriction of distance or time.

Secondly, the present invention may combine advantages of shopping at the real world, in which the buyer may directly and reliably collect information about a product and the buyer is induced to purchase a produce by directly observing a real entity of the product, with advantages of the virtual Electronic Commerce system which has no time or space restriction for the buyer to collect information of the product and purchase the product.

Thirdly, when using the present invention, the stores in the real world may dramatically reduce codes because there are required only products to be exhibited and stands for putting the products thereon without any warehouse.

Fourthly, all members having the IC electronic card are prominent customers of the real store so that the real store may create additional benefit by selling products in the method of the present invention together with an existing direct selling method.

Fifthly, it is also possible to connect all of the real stores to an associated Electronic Commerce network, on the ground of the additional benefit.

Sixthly, the product ID may be provided in a catalogue, which contains information about the product and is distributed to customers from the store.

What is claimed is:

1. A method of purchasing goods in an Internet Electronic Commerce system through identification of an actual entity of the goods, comprising the steps of:
(a) a web server registering a service user as a member by input of user information;
(b) endowing a member ID to the registered member and assigning a virtual cart to each member;
(c) issuing to the member a member card in which the user information is stored;
(d) the member putting a product ID of a product in the virtual cart by presenting the member card while observing the product in a real store;
(e) the web server reading and showing the product ID stored in the virtual cart to the member when the member accesses the web server; and
(f) the member purchasing the product according to a predetermined purchasing procedure.

2. The member as claimed in claim 1,
wherein, in the step (d), when the member presents the member card to a terminal, provided to each product or each product group in the real store,
the terminal automatically reads the user information stored in the member card and transmits the user information to a store server together with the product ID of a product associated to the terminal, and then the store server collects the product IDs from the terminal and puts the collected product IDs into the virtual cart of the corresponding member in the web server.

3. The method as claimed in claim 1,
wherein, in the step (d), when the member presents the member card to a terminal, provided to each product or each product group in the real store,
the terminal automatically reads the user information stored in the member card and transmits the user information to a store server together with the product ID of a product associated to the terminal, and then the store server puts the product ID into the virtual cart of the corresponding member in real time.

4. The method as claimed in claim 1,
wherein, in the step (d), when the member presents the member card to a terminal, provided to each product or each product group in the real store,
the terminal automatically reads the user information stored in the member card and puts the user information into the virtual cart in the web server together with the product ID of a product associated to the terminal, in real time.

5. The method as claimed in claim 1
wherein, in the step (d), there is provided a terminal which has a bar code recognizing device for recognizing a product ID stored in a bar code of each product and a reading device for reading out the user information stored in the member card,
wherein the terminal reads the user information from the member card and the product ID from the bar cord of the product to be purchased and then sends the user information and the product ID to the web server; and
wherein the web server puts the product ID into the virtual cart of the corresponding member.

6. The method as claimed in claim 1,
wherein, in the step (d), there is provided a portable card writer which has a bar code recognizing device for recognizing a product ID stored in a bar code of each product and a product ID writing device for writing the product ID, recognized by the bar code recognizing device, in the member card,
wherein the portable card writer recognizes the product ID from the bar code of a product to be purchased and writes the product ID in the member card,
wherein, when the member presents the member card to a member card reader accessible to the Internet, the member card reader reads out the user information and the product ID from the member card and then sends the user information and the product ID to the web server, and
wherein the web server puts the product ID into the virtual cart of the corresponding member.

7. The method as claimed in claim 1,
wherein, in the step (d), when the member collects product ID cards prepared for each product in a shape of a business card and presents the cards to a card reader,
the card reader reads the user information from the member card and the product ID from the product ID card of the product to be purchased and then sends the user information and the product ID to the web server; and
the web server puts the product information into the virtual cart of the corresponding member.

8. A method of purchasing goods in an Internet Electronic Commerce system through identification of an actual entity of the goods, comprising the steps of:
(i) a web server registering a service user as a member by inputting user information;
(ii) endowing an member ID to the registered member;
(iii) issuing a member card to the member;
(iv) writing a product ID of a product into the member card when the member having the member card desires to purchase the product in a real store;
(v) the member accessing the web server by using the member ID and then reading and sending the product ID written in the member card to the web server by using a user terminal;
(vi) the web server displaying detailed information of the product to the user terminal; and
(vii) the member purchasing the product according to a predetermined purchasing procedure.

9. The member as claimed in claim 8,
wherein, in the step (iv), when the member presents the member card to a terminal, provided to each product or each product group in the real store,
the terminal automatically writes the product ID of the corresponding product in the member card.

10. The member as claimed in claim 8,
wherein, in the step (iv), there is provided a portable card writer having a bar code recognizing device for recognizing the product ID stored in a bar code of each product and a reading device for reading out the user information stored in the member card, and
wherein the portable writer writes the product ID in the member card by recognizing the bar code of the corresponding product.

11. The method as claimed in claim 8,
wherein, in the step (iv), when the member collects product ID cards in a shape of a business card and presents the product ID cards to a store terminal of the real store together with the member card,
the store terminal writes the product ID corresponding to the product ID cards in the member card.

12. A method of purchasing goods in an Internet Electronic Commerce system through identification of an actual entity of the goods, comprising the steps of:
(A) a web server registering a service user as a member by input of user information;
(B) endowing an member ID to the registered member and assigning a virtual cart to each member;
(C) putting a product ID of a product into the virtual cart of the member when the member inputs the member ID and the product ID of a product to be purchased in a terminal while observing the product in a real store;
(D) reading and showing the product ID stored in the virtual cart to the user terminal when the member accesses the web server; and
(E) the member purchasing the product according to a predetermined purchasing procedure.

13. The member as claimed in claim 12,
wherein, in the step (C), when the member inputs the member ID in the terminal, provided to each product or each product group in the real store,
the terminal sends the member ID to a store server together with the product ID associated with the terminal, and
the store server then collects the product IDs and puts the collected product IDs into the virtual cart of the corresponding member in the web server.

14. The member as claimed in claim 12,
wherein, in the step (C), when the member inputs the member ID in the terminal, provided to each product or each product group in the real store,
the terminal sends the member ID to a store server together with the product ID associated with the terminal, and
the store server then puts the product ID into the virtual cart of the corresponding member in the web server, in real time.

15. The member as claimed in claim 12,
wherein, in the step (C), when the member sends the product ID of a product to be purchased by using a portable communication terminal of the member while observing the product in the real store,
the web server puts the product ID into the virtual cart of the corresponding member.

16. A method of purchasing goods in an Internet Electronic Commerce system through identification of an actual entity of the goods, comprising the steps of:
(I) a web server registering a service user as a member by input of user information;
(II) endowing an member ID to the registered member;
(III) obtaining a product ID of a product in a real store while the member is in the real store; and
(IV) the web server providing detailed product information corresponding to the product ID to a user terminal of the member when the member accesses the web server and inputs the product ID.

17. The method as claimed in any of claims 1 to 15,
wherein, when receiving a request of purchasing a product, the web server informs the real store, a manufacturer and a delivery service provider of information about the purchased product so as to manufacture and deliver the product to a buyer.

18. The method as claimed in any of claims 1 to 16,
wherein the product ID substantially includes a store classification code, a product classification code and a date of issue.

19. The method as claimed in any of claims 1 to 11,
wherein the member card is a touch or non-touch IC card or RF electronic card in a shape of a business card.
